(19) United States
(12) Patent Application Publication
(10) Pub. No.: US 2012/0048463 A1
(43) Pub. Date: Mar. 1, 2012

(54) METHOD FOR ADHESIVELY BONDING AND DETACHING WASH-OFF LABELS

(75) Inventors: Carmen-Elena CIMPEANU, Ludwigshafen (DE); Cornelis Petrus BEYERS, Altrip (DE); Andree DRAGON, Speyer (DE); Jose Maria Torres LLOSA, Ludwigshafen (DE); Erika FLAMING, Frankenthal (DE); Uwe WERNZ, Heidelberg (DE)

(73) Assignee: BASF SE, Ludwigshafen (DE)

(21) Appl. No.: 13/220,029

(22) Filed: Aug. 29, 2011

Related U.S. Application Data
(60) Provisional application No. 61/378,411, filed on Aug. 31, 2010.

(51) Int. Cl. B29C 65/14

(52) U.S. Cl. 156/273.7

(57) ABSTRACT

A method is described for adhesively bonding labels to a substrate, in which a radiation-crosslinkable pressure-sensitive adhesive is applied to the label or to the substrate, label and substrate are brought together and bonded to one another, the pressure-sensitive adhesive, prior to bonding, is crosslinked by irradiation, with UV light, for example, with a radiation dose of 6 to 18 mJ/cm², and the pressure-sensitive adhesive, prior to crosslinking, has a glass transition temperature of less than or equal to −40° C. The labels can be washed off with basic, aqueous wash liquid.

A method is described for adhesively bonding and detaching wash-off labels, in which a radiation-crosslinkable pressure-sensitive adhesive is applied to the label or to a substrate, label and substrate are bonded to one another, the pressure-sensitive adhesive, prior to bonding, is crosslinked by irradiation, and the pressure-sensitive adhesive, prior to crosslinking, has a glass transition temperature of less than or equal to −40° C. The labels can be washed off with basic, aqueous wash liquid.

Multi-use reusable containers, such as beer, water or soda bottles in the beverage industry, are subject to high rates of re-use. On each return, the containers are cleaned before being refilled, in a washing operation that also removes the labels. The containers are then refilled and relabeled according to the type of beverage they now contain. Where the containers are standardized for a particular product group, as in the case of a beer bottle, for example, there is no need for the bottles for return to the brewery to be presorted by type of beer, as would be the case with bottles bearing a permanent existing decoration. The different labeling takes place, generally, only after filling. In the case of a direct imprint on the bottle that was not removable by washing, it would be necessary to hold large stock levels of bottles each with the appropriate existing decoration. Within the beverage industry, containers are usually washed with hot wash liquid, such as, for instance, dilute sodium hydroxide solution, heated to 60 to 90° C., and without additional mechanical assistance in the form of brushes, usually.

On account of the standardized wash-off conditions within the beverage industry, it has been usual to date to use paper-based labels and water-soluble, casein-based or starch-based wet glue adhesives. On label wash-off in the washing station, the water permeability of paper is exploited such that the wet glue adhesive typically used enters fairly quickly into full contact with the wash liquid and undergoes complete detachment in the predetermined wash time (in the region of a few minutes), but with the adhesive, then, generally dissolving in the wash liquid. A disadvantage of this is the production of considerable amounts of wastewater contaminated with residues of adhesive. The casein-based label adhesives that are frequently used, in particular, produce severe contamination of the wash water. There is therefore a desire for adhesive systems which cause very little contamination of the wash water.

Frequently there is a desire for “no label look” labels. These are transparent polymeric-film labels which leave the contents of the container visible and give the viewer the impression that the container does not have a label and has instead been directly printed or inscribed. Rather than paper, the backing material used for such labels is polymeric film. A disadvantage of polymeric films is that they do not possess the same high permeability for wash liquid as does paper. Such films prevent the wash liquid accessing the boundary between adhesive and container surface, and so, when conventional adhesive is used, the nonpermeable film labels are only detachable slowly, starting from the edge of the labels, which does not allow complete label detachment within an economically acceptable timeframe in the absence of additional mechanical assistance in the form, for instance, of brushes, high-pressure jet, etc. Such mechanical means are undesirable on account of the higher cost and complexity they entail.

WO 2009/003737 discloses labels with water-removable, UV-curing adhesives. Special labels are used which either consist of water-permeable materials or are perforated. Labels made from conventional materials are not detachable using the bonding methods and adhesives described. WO 01/46329 discloses the use of backing material which dissolves and of adhesive which dissolves in the wash liquid. Although this results in more rapid detachment, it also leads to a high level of unwanted contamination of the wastewater with organic residues. EP 951004 discloses the use of film-backed labels which at elevated temperature in the washing apparatus contract and so change their shape, with forces resulting which are greater than the adhesive forces, thus causing the label to detach. The disadvantage of labels which arch, roll up or otherwise alter their planar shape is the relatively high volume they occupy during the washing operation, which, when using washing apparatus of the type that is standard in the beverage industry, can lead to clogging of the relatively close-meshed baskets used, into which the bottles are inserted individually for the washing operation. Shape-altering or perforated film-based labels of the kind known for improving the detachment behavior are more costly and complicated to produce, furthermore, on account of the pretreatment or aftertreatment needed or on account of the need for a multiple-layer construction, and are therefore also significantly more expensive than standard films. There is, therefore, a desire for an adhesive system that allows even conventional, nonpermeable and insoluble films, more particularly unperforated films which are also dimensionally stable on exposure to heat, to be washed off quickly and reliably with very little contamination of the wash water. A further important requirement of labels for reusable containers is that, while they should be very rapidly detachable using hot wash liquid, they should nevertheless exhibit bonding which is extremely resistant to contact with moisture or water as in the case, for example, of outdoor storage (weather exposure to rain water) or on chilling and in contact with condensation or ice water. The adhesive system ought, moreover, to have little or no adverse health effects, making its use on food and drink containers particularly advantageous. A particular challenge is to find an adhesive system which meets all of the stated, and in some cases divergent, requirements, and which allows the bonding and detachment of labels comprising conventional backing materials.

The problem on which the invention is based is that of providing a method for adhesively bonding and detaching wash-off labels, where labeled articles, under normal storage and chilling conditions, exhibit very high resistance to premature label detachment, but the labels, on washing with hot wash solution, can be detached very rapidly and without residues, the adhesive as far as possible remaining completely on the detached label and as far as possible neither entering the wash water nor leaving residues on the substrate, and having little or no adverse health effects, and with no need for backing material which is specially pretreated or which changes its shape on washing.

The problem is solved in accordance with the invention by a method for adhesively bonding labels to a substrate, where
a radiation-crosslinkable pressure-sensitive adhesive is applied to the label or to the substrate,
label and substrate are brought together and bonded to one another,
the pressure-sensitive adhesive is crosslinked prior to bonding by irradiation with a radiation dose of 6 to 18 mJ/cm²,
   and the pressure-sensitive adhesive comprises at least one radiation-crosslinkable polymer which prior to crosslinking has a glass transition temperature of less than or equal to −40° C.

The term “radiation-crosslinkable” means that the pressure-sensitive adhesive (PSA) comprises at least one compound having at least one radiation-sensitive group, and, on irradiation, a crosslinking reaction is induced. Irradiation is accomplished preferably with actinic radiation, preferably UV light, more particularly UV-C radiation.

The radiation-crosslinkable PSA is applied preferably to one side of the label material. The PSA is then crosslinked by irradiation and in this way an adhesive label is produced. The backing material of the label is preferably water-insoluble, i.e., it does not dissolve in water at room temperature (25° C.) and ideally also not at the temperatures in the washing operation, which may be 55 to 90° C., e.g., 80° C. The backing material may be paper or a polymeric film.

In the case of polymeric films, the backing material is preferably selected from polyolefins (more particularly polyethylene, polypropylene), polyolefin copolymers, PVC, cellulose, polyacetate, polyesters (especially biodegradable polylactates), and cycloolefin copolymer (COC). The thickness of the films is preferably from 10 to 200 μm or from 30 to 100 μm. The polymeric films are preferably films which are not shrink films, are not oriented and/or do not show any changes in shape during wash-off under the effect of heat, or are perforated or water-permeable. Preferred backing materials are paper, polyethylene, polypropylene, cellulose, polyacetate, and polyester.

The label adhered to the substrate is detachable with a basic wash liquid at elevated temperatures of greater than 25° C. The wash liquid has a basic pH, more particularly from 8 to 11, e.g., around 8. The washing temperature in this case is preferably at least 50° C., more particularly 60 to 90° C. A suitable example is 1-2% strength aqueous sodium hydroxide solution.

The text below occasionally uses the designation “(meth)acryl . . . ” and similar designations as an abbreviated notation for “acryl . . . or methacryl . . . ”.

The radiation-crosslinkable pressure-sensitive adhesive (PSA) is preferably an adhesive based on a polymer with a copolymerized photoinitiator. The polymer may be prepared by free-radical polymerization of ethylenically unsaturated monomers with copolymerization of at least one radiation-sensitive, organically polymerizable organic compound. Radiation-sensitive, free-radically polymerizable organic compounds are referred to below for short as polymerizable photoinitiators. The polymerizable photoinitiator may be incorporated into the polymer chain of copolymers by means of free-radical copolymerization. Polymerizable photoinitiators preferably have the following basic structure:

A-X—B

where A is a monovalent organic radical which as its radiation-sensitive group preferably has a phenone group,
X is an ester group selected from —O—C(═O)—, —(C═O)—O, and —O—(C═O)—O—, and
B is a monovalent organic radical which comprises an ethylenically unsaturated, free-radically polymerizable group. Preferred radicals A are radicals which comprise at least one structural element derived from phenones, more particularly from acetophenones or benzophenones. Preferred radicals B comprise at least one, preferably just one acrylic or methacrylic group.

The ethylenically unsaturated group may be attached directly to the group X. It is also possible for the radiation-sensitive group to be attached directly to the group X. Alternatively, between ethylenically unsaturated group and group X, or between radiation-sensitive group and group X, there may in each case be a spacer group positioned. The spacer group may have, for example, a molecular weight of up to 500, more particularly up to 300 or 200 g/mol.

Suitable photoinitiators are, for example, compounds with acetophenone or benzophenone structural units, as described in EP 377191 A or EP 1213306 A, for example. A preferred group X is the carbonate group —O—(C═O)—O—. Preferred polymerizable photoinitiators are compounds of the formula:

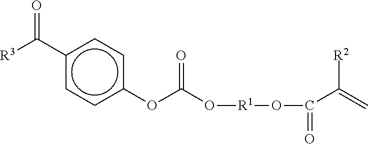

in which R1 is an organic radical having up to 30 C atoms, R2 is an H atom or a methyl group, and R3 is a substituted or unsubstituted phenyl group or is a C1-C4 alkyl group. R1 is more preferably an alkylene group, more particularly a C2-C8 alkylene group. R3 is more preferably a methyl group or a phenyl group, very preferably a phenyl group.

Further acetophenone derivatives and benzophenone derivatives that are suitable as copolymerizable photoinitiators are, for example, those of the formula

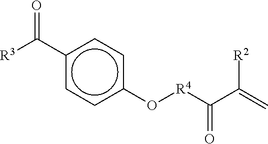

in which R2 and R3 may be as defined above and R4 may be a single bond or (—CH₂—CH₂—O)ₙ, where n is an integer from 1 to 12.

The radiation-crosslinkable PSA comprises, as principal or sole active adhesive ingredient, preferably a polymer which is obtainable by free-radical polymerization of acrylic monomers, a term which below also comprehends methacrylic monomers, and, optionally, of further, copolymerizable monomers. Preferably it is a poly(meth)acrylate polymer composed of at least 40%, more preferably at least 60%, very preferably at least 80% by weight of C1 to C10 alkyl (meth)acrylates and which comprises at least one copolymerized photoinitiator. Mention may be made more particularly of C1-C8 alkyl(meth)acrylates, such as methyl(meth)acrylate, ethyl acrylate, n-butyl acrylate, n-hexyl acrylate, and 2-ethylhexyl acrylate. In one embodiment of the invention the poly(meth)acrylate polymer is composed of at least 80% by weight of at least one acrylate selected from the group consisting of n-butyl acrylate, n-hexyl acrylate, 2-ethylhexyl acrylate, and mixtures thereof, or the poly(meth)acrylate polymer is composed of at least 90% by weight of 2-ethylhexyl acrylate. In all cases, the nature and amount of the respective monomers are adjusted such that the polymer prior to crosslinking has a glass transition temperature of less than or equal to −40° C.

The polymer is preferably a poly(meth)acrylate polymer which is crosslinkable with UV light and in which the photoinitiator is copolymerized, i.e., attached to the polymer. By irradiation with high-energy light, more particularly UV light, the photoinitiator brings about crosslinking of the polymer, preferably by means of a chemical grafting reaction of the photoinitiator with a spatially adjacent polymer chain. More particularly the crosslinking may take place through insertion of a carbonyl group of the photoinitiator into an adjacent C—H bond, with formation of a —C—C—O—H moiety. The polymer comprises preferably 0.0001 to 1 mol, more preferably 0.0002 to 0.1, very preferably 0.0003 to 0.01 mol of the photoinitiator, or of the molecular group attached to the polymer and effective as a photoinitiator, per 100 g of polymer.

Further, non-acrylate monomers of which the radiation-crosslinkable polymer may additionally be composed are, for example, vinyl esters of carboxylic acids comprising up to 20 C atoms, vinyl aromatics having up to 20 C atoms, ethylenically unsaturated nitriles, vinyl halides, vinyl ethers of alcohols comprising 1 to 10 C atoms, aliphatic hydrocarbons having 2 to 8 C atoms and 1 or 2 double bonds, or mixtures of these monomers. Examples of suitable vinyl aromatic compounds include vinyltoluene, α- and p-methylstyrene, alpha-butylstyrene, 4-n-butylstyrene, 4-n-decylstyrene, and, preferably, styrene. Examples of nitriles are acrylonitrile and methacrylonitrile. The vinyl halides are chlorine-, fluorine-, or bromine-substituted ethylenically unsaturated compounds, preferably vinyl chloride and vinylidene chloride. Examples of vinyl ethers include vinyl methyl ether and vinyl isobutyl ether. Preference is given to vinyl ethers of alcohols comprising 1 to 4 C atoms. Hydrocarbons having 2 to 8 C atoms and two olefinic double bonds include butadiene, isoprene, and chloroprene. Further suitable monomers also include, in particular, monomers having carboxylic, sulfonic or phosphonic acid groups. Carboxylic acid groups are preferred. Examples include acrylic acid, methacrylic acid, itaconic acid, maleic acid or fumaric acid. Further monomers are, for example, also (meth)acrylamide and monomers comprising hydroxyl groups, especially C1-C10 hydroxyalkyl(meth)acrylates. Mention may additionally be made of phenyloxyethylglycol mono(meth)acrylate, glycidyl acrylate, glycidyl methacrylate, and amino(meth)acrylates such as 2-aminoethyl(meth)acrylate. Monomers which as well as the double bond also carry other functional groups, examples being isocyanate-, amino-, hydroxy-, amide- or glycidyl-, may have the effect, for example, of improving the adhesion to substrates.

The radiation-crosslinkable polymers can be prepared by copolymerizing the monomeric components, including the copolymerizable photoinitiator, using the customary polymerization initiators and also, optionally, regulators (chain transfer agents), with polymerization taking place at the customary temperatures in bulk, in emulsion, such as in water or liquid hydrocarbons, for example, or in solution. Preferably the polymers are prepared either by emulsion polymerization in water or by polymerization of the monomers in organic solvents, more particularly in organic solvents with a boiling range of 50 to 150° C., preferably of 60 to 120° C., using the customary amounts of polymerization initiators, these amounts being, generally, 0.01% to 10%, more particularly 0.1% to 4%, by weight, based on the total weight of the monomers.

The polymers can be prepared at temperatures of 20 to 150° C., preferably at temperatures in the range from 70 to 120° C. and at pressures of 0.1 to 100 bar (absolute), preferably at 0.3 to 10 bar, in the presence of 0.01% to 10% by weight of peroxides or azo initiators as polymerization initiators, based on the monomers, and in the presence of 0% to 200% by weight of inert solvents, preferably 5% to 25% by weight, based on the monomers, i.e., by solution polymerization or bulk polymerization. The reaction takes place preferably with a progression in reduced pressure, by means, for example, of the lowering of the pressure from atmospheric pressure (1 bar) to 500 mbar (absolute). Solvents are, for example, hydrocarbons, alcohols such as methanol, ethanol, propanol, butanol, and isobutanol, ketones such as acetone, methyl ethyl ketone, and methyl isobutyl ketone, ethyl acetate, nitriles such as acetonitrile and benzonitrile, or mixtures of the solvents stated. In one preferred embodiment the solvents used for the polymerization are one or more ketones having a boiling point of below 150° C. under atmospheric pressure (1 bar).

Examples of suitable polymerization initiators include azo compounds, ketone peroxides, and alkyl peroxides, e.g., acyl peroxides such as benzoyl peroxide, dilauroyl peroxide, didecanoyl peroxide, and isononanoyl peroxide, alkyl esters such as tert-butyl tert-pivalate, tert-butyl per-2-ethylhexanoate, tert-butyl permaleate, tert-butyl perisononanoate, tert-butyl perbenzoate, and tert-amyl per-2-ethylhexanoate, dialkyl peroxides such as dicumyl peroxide, tert-butyl cumyl peroxide, and di-tert-butyl peroxide, and peroxodicarbonates. As initiators it is additionally possible to use azo initiators such as, for example, 2,2′-azobisisobutyronitrile, 2,2′-azobis(methyl isobutyrate) or 2,2′-azobis(2,4-dimethylvaleronitrile).

For the implementation of the polymerization it is also possible to admix the reaction mixture with compounds that lower the degree of polymerization, these being referred to as polymerization regulators (chain transfer agents), in amounts, for example, of 0.1 to 0.8 part by weight per 100 parts by weight of the monomers to be polymerized. Suitability is possessed, for example, by compounds having a thiol group, examples being mercaptans such as mercapto-ethanol, tert-butyl mercaptan, mercaptosuccinic acid, ethylhexyl thioglycolate, 3-mercapto-propyltrimethoxysilane or dodecyl mercaptan. In one embodiment no molecular weight regulators are used.

The glass transition temperature (Tg) of the radiation-crosslinkable polymer is less than or equal to −40° C. or less than or equal to −50° C. or less than or equal to −55° C., preferably from −60 to −40° C. or from −60 to −50° C. The glass transition temperature can be determined by standard methods such as differential thermal analysis or differential scanning calorimetry (see, for example, ASTM 3418/82, midpoint temperature). The radiation-crosslinkable polymer preferably has a K value of 30 to 80, more preferably of 40 to 60, measured in tetrahydrofuran (1% strength solution, 21° C.). The K value of Fikentscher is a measure of the molecular weight and the viscosity of the polymer.

By means of what is called the Fox equation it is possible for a skilled person to identify copolymers in the suitable Tg range beforehand and to prepare them specifically through appropriate variation of type and amount of the monomers. According to Fox (T. G. Fox, Bull. Am. Phys. Soc. 1956 [Ser. II] 1, page 123, and in accordance with Ullmann's Encyclopädie der technischen Chemie, volume. 19, page 18, 4^{th} edition, Verlag Chemie, Weinheim, 1980), the glass transition temperature of copolymers with no more than low levels of crosslinking is given in good approximation by:

1/T_{g}=x¹/T_{g}¹+x²/T_{g}²+ . . . xⁿ/T_{g}ⁿ,

where x¹, x², . . . xⁿ are the mass fractions of the monomers 1, 2, n, and T_{g}¹, T_{g}², . . . T_{g}ⁿ are the glass transition temperatures of the polymers constructed in each case only from one of the monomers 1, 2, . . . n, in degrees Kelvin. The T_{g} values for the homopolymers of the majority of monomers are known and are listed in, for example, Ullmann's Encyclopedia of Industrial Chemistry, Vol. A21, 5^{th} edition, page 169, VCH Weinheim, 1992; other sources of homopolymer glass transition temperatures include, for example, J. Brandrup, E. H. Immergut, Polymer Handbook, 1^{st} Edition, J. Wiley, New York 1966, 2^{nd} Edition, J. Wiley, New York 1975, and 3^{rd} Edition, J. Wiley, New York 1989).

The radiation-crosslinkable PSA is used preferably as what is called a hotmelt PSA, i.e., in solvent-free, meltable form. Solvent inherent in the preparation process is removed beforehand by suitable methods, preferably down to a residual level of less than 0.5% by weight, based on the polymer. To produce coatings, the hotmelt PSAs are applied as a melt to the materials to be coated, labels for example, the coated surface being coated at least partly with an adhesive of the invention. The hotmelt PSA may be applied as a melt, i.e., in general, at temperatures from 80 to 160° C. The application rate of the PSA is preferably from 10 to 20 g/m², more preferably from 12 to 18 g/m² or from 14 to 16 g/m². Preferred layer thicknesses are, for example, 10 to 20 micrometers.

The crosslinkable polymers may then be irradiated with high-energy radiation, preferably UV light, more particularly UV-C radiation (200-280 nm), and so crosslinking takes place. Generally speaking, for this purpose, the coated substrates are placed on a conveyor belt and the belt is conveyed past a radiation sources, a UV lamp, for example. The degree of crosslinking of the polymers is dependent on the duration and intensity of the irradiation. The radiation dose in accordance with the invention is from 6 to 18 mJ/cm², preferably from 6 to 15 mJ/cm², from 8 to 15 mJ/cm² or from 8 to 12 mJ/cm². UV emitters used may be the customary emitters, examples being medium-pressure mercury lamps with a radiant output of 80 to 240 watts/cm.

The ratio of radiation dose to application rate is preferably from 3 to 15 J/g or from 4 to 13 J/g.

For producing pressure-sensitive adhesive labels, the PSA may also, for example, be applied by transfer application to carriers such as paper or polymer films, by first being applied to abhesively coated backing materials, such as siliconized paper, for example, and irradiated, and then being laminated, for example, onto paper. Following the removal of the siliconized paper, the tacky layer may optionally be irradiated again. The pressure-sensitive adhesive bonding systems may be modified and/or converted into a form which is customary per se.

The PSA of the invention is a material which, in particular after crosslinking by irradiation, has pressure-sensitive adhesive properties. A PSA is a viscoelastic adhesive whose set film at room temperature (20° C.) in the dry state remains permanently tacky and adhesive.

The adhesive-coated label is adhered onto a substrate, such as a plastic or glass packaging form, more particularly a beverage bottle. Preferred packaging forms are forms of food packaging, examples being bottles made of glass or of plastic, such as of polyethylene terephthalate, for example. Other suitable substrates include trays or platters of the kind used in aircraft, for example. The label can be removed by washing with a heated, basic wash liquid. The temperature of the wash liquid is greater than 25° C., preferably at least 50° C., e.g., 60 to 90° C., or around 80° C. The pH of the wash liquid is basic, i.e., greater than 7, more particularly from 9 to 11, e.g., around 10.

The invention therefore also provides a method for adhesively bonding labels to a substrate and subsequently detaching the labels, where the labels as described above are bonded to a substrate and detached from the substrate again using basic, aqueous wash liquid at temperatures greater than 25° C. With adhesive labels of the invention, following adherence to a substrate (e.g., glass or plastic such as polyethylene terephthalate, for example) and subsequent detachment of the label with basic, aqueous wash liquid, preferably at least 95% by weight, more particularly 97% to 100% by weight, of the PSA remains adhering to the detached label. At the end of the washing operation, preferably not more than 5% or not more than 2%, e.g., 0% to 2%, of undetached labels remain on the substrate.

Effective detachability does not necessarily require the adhesive label to be water-permeable or perforated or to have similar auxiliary means for allowing rapid contact between wash water and adhesive during the washing operation. In accordance with the invention, sufficiently rapid detachment of the label from the substrate is possible even without such auxiliary means. Nor is it absolutely necessary for the label to change its shape during the washing operation, in order to facilitate label detachment by means of the forces that accompany the change in shape. Preference, therefore, is given to adhesive labels in which the backing material is not water-permeable or perforated or is dimensionally stable under wash-off conditions.

The adhesive labels of the invention are notable for the fact that even after prolonged outdoor storage, which normally results in deterioration in the wash-removability, the labels can still be washed off rapidly and without residue, in particular also when polymeric-film labels are used, which are normally difficult to detach on account of their water-impermeability.

The invention also provides for the use of the radiation-crosslinkable, pressure-sensitive adhesive described in more detail above for producing labels which, following irradiation with a radiation dose of 5 to 18 mJ/cm², can be bonded and can be washed off, the pressure-sensitive adhesive comprising at least one radiation-crosslinkable polymer which prior to crosslinking has a glass transition temperature of less than or equal to −40° C.

### EXAMPLES

Unless the context indicates otherwise, the amounts in percent are always percent by weight. The indication of a content relates to the content in aqueous solution or dispersion.

### Example B1

Hotmelt PSA: acrylate copolymer of 2-ethylhexyl acrylate, methyl methacrylate, and copolymerized photoinitiator

### Tg=−60° C.

### Comparative Example C1

Hotmelt PSA acResin 204 UV: acrylate copolymer of n-butyl acrylate, 2-ethylhexyl acrylate, methyl acrylate, acrylic acid, and copolymerized photoinitiator

### Tg=−34° C.

### Wash-Off Tests

Film-backed labels comprising polyethylene films with a thickness of 85 μm (Renolit® PE 85μ) and a size of 60×80 mm were coated with hotmelt PSA, in the amounts indicated in each case in the table below, and, after drying, were adhered to glass bottles.

Following storage of the labeled bottles, the labels were detached at 75-80° C. using a wash liquid (2% strength aqueous NaOH solution, 0.5% Calgonit® 1144). A measurement was made of the time taken for the label to detach completely, and the shape of the detached label was assessed. The results are summarized in the table below.

TABLE 1
Wash-off tests, film-backed labels

| | | | | | Detachment | |
|---|---|---|---|---|---|---|
| | Appli- | | Detachment | | time after | |
| | cation | UV-C | time after | | outdoor | Label shape |
| | rate | dose | storage for | | weathering | after |
| Example | [g/m²] | [mJ/cm²] | 7 days | | for 30 days | detachment |
| B1 | 14-16 | 8 | 15-50 s | | 20-50 s | smooth, |
| Tg | | | | | | dimensionally |
| −60° C. | | | | | | stable |
| B1 | 20 | 15 | 24 | s | | |
| Tg | | | | | | |
| −60° C. | | | | | | |
| B1 | 20 | 5 | >8 | min | | no complete |

| | | | | | |
|---|---|---|---|---|---|
| Tg | | | | | detachment |
| −60° C. | | | | | |
| C1 | 14-16 | 20 | still 100% | still 100% | no |
| Tg | | | bonding | bonding | detachment |
| −34° C. | | | after 10 min | after 10 min | |
| C1 | 14-16 | 10 | still 100% | still 100% | no |
| Tg | | | bonding | bonding | detachment |
| −34° C. | | | after 10 min | after 10 min | |

The inventive examples exhibit adhesive fracture of the layer of adhesive on detachment, i.e., the adhesive remains adhering to the label, without residues remaining on the glass bottle.

The inventive examples score over the comparative compositions through an unexpected combination of advantageous properties in terms both of effective detachment even after prolonged outdoor weathering and of smooth, planar label shapes after detachment, thereby lessening the risk of blocking of the wash apparatus.

1. A method for adhesively bonding labels to a substrate, where
a radiation-crosslinkable pressure-sensitive adhesive is applied to the label or to the substrate,
label and substrate are brought together and bonded to one another,
the pressure-sensitive adhesive is crosslinked prior to bonding by irradiation with a radiation dose of 6 to 18 mJ/cm²,
and the pressure-sensitive adhesive comprises at least one radiation-crosslinkable polymer which prior to crosslinking has a glass transition temperature of less than or equal to −40° C.

2. The method according to the preceding claim, wherein the application rate of the pressure-sensitive adhesive is 12 to 18 g/m².

3. The method according to either of the preceding claims, wherein the ratio of radiation dose to application rate is from 3 to 15 J/g.

4. The method according to any of the preceding claims, wherein the radiation-crosslinkable polymer prior to crosslinking has a glass transition temperature of −40 to −60° C.

5. The method according to any of the preceding claims, wherein the irradiation takes place with UV light.

6. The method according to any of the preceding claims, wherein the pressure-sensitive adhesive comprises at least one radiation-crosslinkable poly(meth)acrylate polymer, the poly(meth)acrylate polymer being composed of at least 60% by weigh of C1 to C10 alkyl (meth)acrylates and comprising at least one copolymerized photoinitiator.

7. The method according to the preceding claim, wherein the photoinitiator in uncopolymerized form has the general structure
A-X—B, where
A is a monovalent organic radical which contains a phenone group,
X is an ester group selected from —O—C(═O)—, —(C═O)—O, and —O—(C═O)—O—, and
B is a monovalent organic radical which comprises an ethylenically unsaturated, free-radically polymerizable group.

8. The method according to the preceding claim, wherein the photoinitiator in uncopolymerized form has the general structure 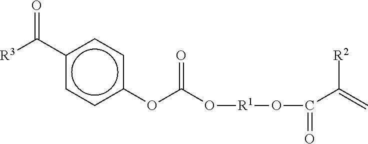
in which R1 is a divalent organic radical having up to 30 C atoms, R2 is an H atom or a methyl group, and R3 is a substituted or unsubstituted phenyl group or is a C1-C4 alkyl group.

9. The method according to any of the preceding claims, wherein the pressure-sensitive adhesive comprises at least one radiation-crosslinkable poly(meth)acrylate polymer, the poly(meth)acrylate polymer being composed of at least 80% by weight of at least one acrylate which is selected from the group consisting of n-butyl acrylate, n-hexyl acrylate, 2-ethylhexyl acrylate, and mixtures thereof.

10. The method according to any of the preceding claims, wherein the pressure-sensitive adhesive comprises at least one radiation-crosslinkable poly(meth)acrylate polymer, the poly(meth)acrylate polymer being composed of at least 90% by weight of 2-ethylhexyl acrylate.

11. The method according to any of the preceding claims, wherein the backing material of the label is selected from paper, polyethylene, polypropylene, cellulose, polyacetate, and polyester.

12. The method according to any of the preceding claims, wherein the backing material of the label is not perforated and is dimensionally stable under wash-off conditions.

13. The method according to any of the preceding claims, wherein the substrate is selected from packaging having surfaces of glass or of plastic.

14. A method for adhesively bonding labels to a substrate and subsequently detaching the labels, the labels being bonded to a substrate in accordance with any of the preceding claims, and detached from the substrate again with basic, aqueous wash liquid at temperatures greater than 25° C.

15. The method according to the preceding claim, wherein the detachment with a wash liquid takes place with a pH of 9 to 11 and at a temperature of 60 to 90° C.

16. The method according to either of the two preceding claims, wherein, following the detachment of the label with basic, aqueous wash liquid, the pressure-sensitive adhesive remains adhering to the detached label to an extent of at least 95% by weight and/or not more than 2% of undetached labels remain on the substrate.

17. The use of radiation-crosslinkable pressure-sensitive adhesive for producing labels which after irradiation with a radiation dose of 6 to 18 mJ/cm² can be adhesively bonded and washed off, the pressure-sensitive adhesive comprising at least one radiation-crosslinkable polymer which prior to crosslinking has a glass transition temperature of less than or equal to −40° C.
